(19) United States
(12) Patent Application Publication
(10) Pub. No.: US 2006/0179392 A1
(43) Pub. Date: Aug. 10, 2006

(54) Handshakeless retransmission protocol

(76) Inventor: Takaaki Ota, San Diego, CA (US)

Correspondence Address: MILLER PATENT SERVICES, 2500 DOCKERY LANE, RALEIGH, NC, 27606, US

(21) Appl. No.: 11/053,247

(22) Filed: Feb. 8, 2005

(51) Int. Cl. H04L 1/18

(52) U.S. Cl. 714/749

(57) ABSTRACT

A retransmission method for use in handshakeless communication consistent with certain embodiments involves transmitting a sequence of packets from a packet source to a packet receiving device, each packet in the sequence of packets having a sequence number associated therewith, said transmitting including retrieving a next packet from a transmission buffer and transmitting said next packet; at the packet receiving device, determining that a packet has not been received by determining that a gap exists in the sequence numbers of received packets; sending a retransmission request from the receiving device to the transmitting device, such retransmission request requesting retransmission of a specified packet whose sequence number is in the gap in sequence numbers; at the packet source, receiving the retransmission request for the specified packet; at the packet source, determining if the specified packet remains available in the transmission buffer; if the specified packet is available in the transmission buffer, retransmitting the specified packet to the receiving device; and if the specified packet is not available in the transmission buffer, ignoring the retransmission request. This abstract is not to be considered limiting, since other embodiments may deviate from the features described in this abstract.

### BACKGROUND

Communication systems often involve data channels which transfer data packets using an “acknowledged protocol.” An example of an acknowledged protocol is the transport control protocol (TCP) as used in the Internet. An acknowledged protocol is designed to provide reliable point-to-point data transfer and thereby provides methods to retransmit data packets found to be in error. Error control codes such as CRC codes are often sent to allow a receiver to determine whether a received data packet contains errors. If the data packet does contain errors, a retry-request packet is forwarded back to the transmitter so the errant packet may be resent.

An example of a non-acknowledged protocol is the user datagram protocol (UDP) as also used in the Internet. When a UDP packet is sent, no acknowledge is required. Rather UDP packets can be flooded across a network to one or more destinations using broadcast or multicast methods. A broadcast involves sending one or more packets to all nodes on the network. A multicast involves sending one or more packets to more than one node on the network, but not necessarily all of the nodes. When compared to TCP, UDP packet streams also consume less bandwidth because no acknowledge packets and no resent packets are associated with the UDP packet stream. For certain data types such as real-time multimedia viewers and players, a late packet is simply discarded, just like an erroneous packet. Hence network bandwidth is conserved by not re-transmitting data which will only be later discarded at the receiving end. Also, UDP packets enable broadcast and multicast data transfer methods. The cost of using a non-acknowledged protocol such as UDP is the loss in reliability of data.

UDP packets are often used within protocols designed to provide data transmissions having guaranteed bandwidth and on-time delivery. The resource reservation protocol (RSVP) is one example. RSVP is a protocol employed by network routers to establish a path with guaranteed bandwidth and packet delivery times. RSVP and similar protocols are needed to insure multimedia data streams involving real-time voice and video data can be played by a media player at a receiving end of a connection with a specified QOS.

RTP (Real-time Transmission Protocol) is a protocol that is used over UDP or TCP in order to achieve a predictable delay and reduced jitter. But, with RTP, delivery of packets is still not guaranteed. Generally speaking, in order to achieve guaranteed delivery of packets, a handshake protocol is required in which receipt of packets is acknowledged (ACK), or non-receipt of packets is acknowledged (NACK). When packets are not received, a retransmission is undertaken.

Unfortunately, when using UDP or similar protocols, the overlay of such handshaking protocols often results in unacceptable delays, since UDP is primarily used for time sensitive delivery of packets (e.g., streaming audio or video).

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of an exemplary communication system consistent with certain embodiments of the present invention.

FIG. 2 is a flow chart of a receiver process consistent with certain embodiments of the present invention.

FIG. 3 is a flow chart of a transmitter process consistent with certain embodiments of the present invention.

FIG. 4 is an illustration of buffers consistent with certain embodiments of the present invention.

FIG. 5 is a flow chart describing operation of a preferred linked list method for the receive buffer consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

When packets such as UDP packets are utilized for conveying packets from one point to the next, it is usually used in circumstances where absolute assurance of receipt of all packets is not essential. Generally, UDP and similar protocols are utilized when the timing of packet receipt outweighs the need for each and every packet to arrive at the recipient. Examples are streaming audio and video data and voice. Missing packets in such data can be handled by various algorithms that are known in the art. That said, it is certainly desirable that all packets be received, it is simply not the highest priority. While several protocols have been developed to help assure “best efforts” in retransmission of lost packets, they often involve complex algorithms, additional hardware cost, and/or significant computational complexity. Moreover, for UDP packets and similar protocols, the process must be very quick in order to be useful, since the useful life of a packet in many instances is very short. For instance, if UDP is used to stream audio data, a missing packet can only be replaced if the retransmission occurs and is received in enough time to insert the missing packet into the playback stream. Otherwise, any retransmission technique is useless.

Certain embodiments consistent with the present invention seek to ameliorate the condition of lost packets using a very simple and inexpensive algorithm that takes advantage of a retransmission protocol that requires no handshakes and is easily implemented using minimal or no additional hardware at transmitter and receiver. Additionally, the protocol, by it's very simplicity is quick enough to achieve rapid retransmissions thus increasing the odds that a lost packet can be replaced before its useful life ends.

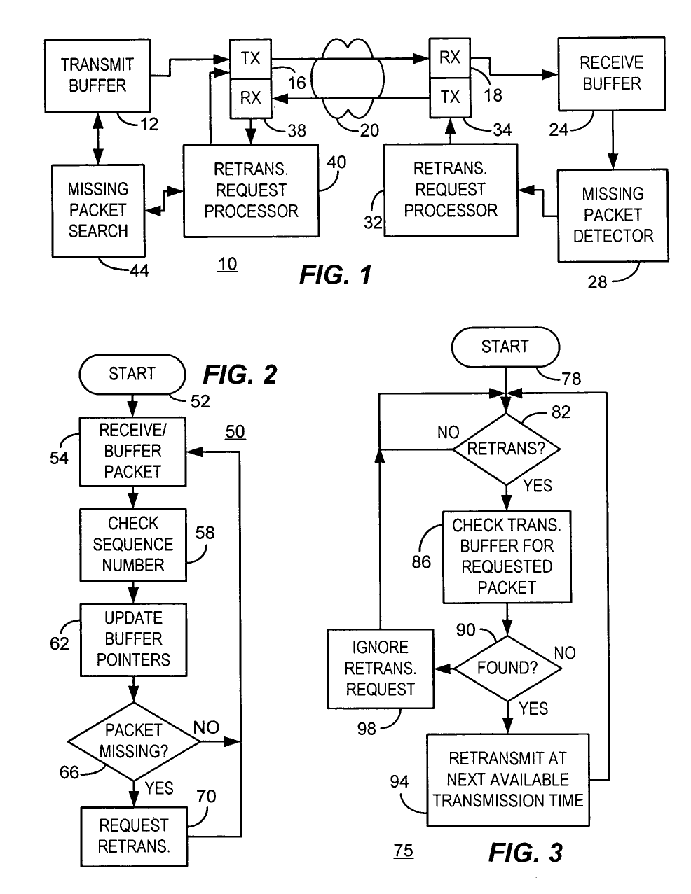

Turning now to FIG. 1, a block diagram of an exemplary system consistent with certain embodiments is depicted as system 10. For purposes of this discussion, the blocks to the right of the cloud 20 represent a receiving device, while the blocks to the left of the cloud 20 represent a transmitting device or packet source, with respect to the flow a data packets. During normal operation, the transmit buffer 12 receives data from a source (e.g., a disc drive, optical disc, a tuner for broadcasted signal etc.) at a rate governed by the source for transmission using transmitter 16. The data received is normally formatted as a sequence of packets such as UDP packets, each bearing a sequence number. Transmitter 16, transmits the sequence of packets to a receiver 18 via a network, or other medium (e.g., a wireless communication link) depicted as 20 as fast as the network bandwidth allows. Once received, the receiver 18 places the received packets in a receive buffer 24 for subsequent retrieval by, for example an audio or video player device.

So long as all packets are received in sequence, the system functions in a normal manner to permit, for example, playback of streaming video from the source of packets at the receiver device. As operation progresses, new data are loaded into the transmit buffer 12, which operates as a FIFO (first in first out) device, and are similarly extracted as needed from the receive buffer 24 which also acts as a FIFO buffer.

By virtue of the protocol in use, it is often the case that for one reason or another, a transmitted packet is not properly received at the receiver device. In this instance, the absence of the packet is detected, for example by noting a gap in the sequence numbers of received packets. This detection is represented in this diagram as missing packet detector 28. Upon detection of a missing packet, the missing packet detector 28 requests that a retransmission request be sent. This is shown symbolically as retransmission request processor 32, which sends a retransmission request via transmitter 34 to the packet source's receiver 38. In certain preferred embodiments, this request is also in the form of a UDP or similar protocol packet for which there is no handshake or other acknowledgment, thus keeping the retransmission request simple, even though there is no guarantee of delivery of the request.

When the retransmission request is received at the receiver 38, the retransmission request is decoded and processed at retransmission request processor 40 which carries out a missing packet search of the transmit buffer 12. Part of the speed and simplicity of the present embodiment lies in the fact that the search is only conducted on the transmit buffer 12. If the missing packet has not been discarded by the transmit buffer 12, the missing packet placed back in the transmission queue and is retransmitted at the earliest available transmission time using transmitter 16. If the missing packet has been replaced in the transmit buffer 12, the retransmission request is simply discarded. No further effort need be made to retransmit the packet.

If the retransmitted packet is received at receiver 18 in time to be placed in the active portion of the receive buffer 24 (i.e., before the packet subsequent to the retrieved packet has been pulled from receive buffer 24 for consumption at the receiver device), then the retransmitted packet is able to be used in the received packet stream. If the retransmitted packet arrives too late, it is simply discarded.

This protocol remains devoid of acknowledgements or negative acknowledgments or other handshaking operations that detract from data throughput while providing a mechanism to recover a portion of the packets lost in a UDP or similar protocol packet session. Moreover, no delays are encountered retrieving old packets from outside the transmit buffer and no delays are encountered predicting whether or not a retransmitted packet is likely to be received in time at the receiving device. The process as described remains simple, and capable of recovering a portion of the packets lost in transmission. While not guaranteeing that all packets are received, a reasonable recovery effort for lost packets is attempted while incurring virtually no penalties. The detection of missing packets can be carried out with minimal computational complexity as can the search for missing packets. In many systems, this can be accomplished using an existing control processor or a very simple state machine or other logic. Depending primarily upon transmission latency, significant numbers of lost packets can be recovered.

Thus, a transmitter device for handshakeless communication consistent with certain embodiments has a transmitter that transmits a sequence of packets from a packet source to a packet receiving device, each packet in the sequence of packets having a sequence number associated therewith, said transmitting including retrieving a next packet from a transmission buffer and transmitting said next packet. A transmitter receives a retransmission request for a specified sequence of packets. The retransmission request may be made up of the starting sequence number and the number of sequential packets. If the specified group of packets remains available in the transmission buffer, the specified packets are retransmitted to the receiving device; and if the specified packets are not available in the transmission buffer, the retransmission request is ignored.

Turning now to FIG. 2, an exemplary process 50 as would be carried out by the receiving device starting at 52. At 54, a packet is received and buffered after or during which the sequence number is checked at 58. The sequence number is used in this example to determine if a packet in the sequence of packets is missing. Whenever a packet is received and placed in the receive buffer 24, or extracted from the buffer (not shown) the buffer pointers are updated at 62. The buffer pointers are used to indicate various attributes of the data in the receive buffer, such as the top and bottom of the unused data. In the preferred embodiment, the packets in buffer 24 are tracked using a double linked list in which each sequential packet is associated with data indicating the next packet and the previous packet in the sequence. If the sequence contains a gap, the double linked list points to the “most nearly” next or previous packet. For example, if the packet sequence in the buffer is 1, 2, 3, 5, 6 . . . , a gap appears between packet number 3 and packet number 5. Thus, the linked list will indicate that the next packet after 3 is 5, and conversely, the packet prior to 5 is 3.

Gaps in the list are tracked, in the preferred embodiment using a second double linked list. The second list contains null values when no gaps are present, but contains data identifying the missing packets by sequence number when gaps are present.

Each of these lists and the pointers indicating the beginning and end of fresh data are updated at 62. At 66, the process determines if a packet is missing, i.e., is there a gap in packet sequence numbers. If not, control returns to 54 to await receipt of the next packet. If so, a retransmission request is generated at 70 and sent to the source of the stream of packets. The operation of the receiver side for a preferred embodiment will be explained in greater detail later.

Referring now to FIG. 3, a flow chart 75 depicts operation of the retransmission request processor in an embodiment consistent with the present invention, starting at 78. At 82, if a retransmission request is received, the transmitter buffer 12 is checked at 86 to determine if the packet for which a retransmission is requested is present or not. If the packet is found at 90, it is retransmitted at the next available transmission time at 94. Control then returns to 82 to await the next retransmission request. If the packet is not found in the transmitter buffer 12 at 90, the retransmission request is ignored at 98 and control again passes back to 82 to await the next retransmission request.

Thus, a retransmission method for use in handshakeless communication consistent with certain embodiments involves transmitting a sequence of packets from a packet source to a packet receiving device, each packet in the sequence of packets having a sequence number associated therewith, said transmitting including retrieving a next packet from a transmission buffer and transmitting said next packet; at the packet receiving device, determining that a packet has not been received by determining that a gap exists in the sequence numbers of received packets; sending a retransmission request from the receiving device to the transmitting device, such retransmission request requesting retransmission of a sequence of specified packets whose sequence numbers fill in the gap in sequence numbers; at the packet source, receiving the retransmission request for the specified sequence of packets; at the packet source, determining if the specified packets remain available in the transmission buffer; if the specified packets are available in the transmission buffer, retransmitting the specified packets to the receiving device; and if the specified packets are not available in the transmission buffer, ignoring the retransmission request.

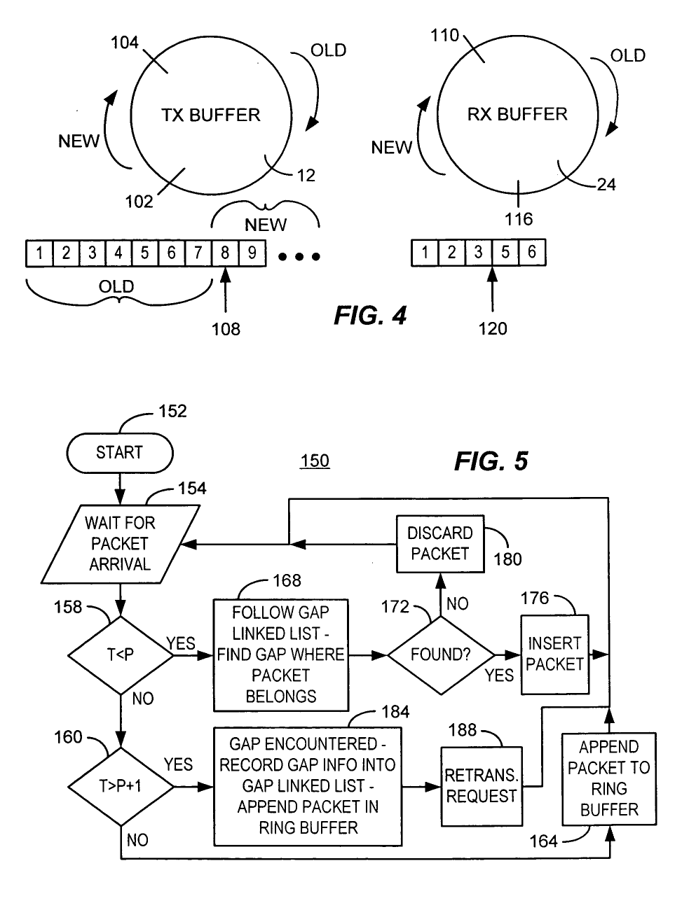

The operation of the transmitter and receiver buffers 12 and 24 respectively is depicted in FIG. 4 which depicts both buffers as both circular and linear. The transmit buffer 12 is depicted on the left and the receive buffer is depicted on the right. In certain embodiments consistent with the present invention, both the transmit and receive buffers 12 and 24 are circular FIFO buffers. In the case of buffer 12, two pointers are 102 and 104 are used to mark the beginning and end of new data (and possibly some retransmission data) that are in queue for transmission. As new data enters the buffer, pointer 104 is advanced in the direction of the arrow labeled “NEW”. The region of the buffer labeled “NEW” represents data to be transmitted. Old data are labeled “OLD” and are represented by the arrow with similar legend. Thus, as new data are received for transmission, the region carrying new data expands at the end marked by pointer 104. As data are extracted from the buffer, pointer 102 similarly moves in the direction of the arrow labeled “NEW”.

Data that have already been transmitted are not purged from the buffer until replaced by new data. Thus, the portion of the circular buffer labeled “OLD” will contain the most recently transmitted data.

In the linear representation of the buffer shown below circular buffer 12, it can be seen that, at the instant illustrated, packets 1-7 have already been transmitted. Packet 8 is currently being transmitted as indicated by arrow 108 and additional packets starting with packet 9 are awaiting transmission.

At the receive buffer 24, a similar circular buffer can be used. In this case, however, the data designated “OLD” is not particularly relevant to the current discussion. The buffer 24, however, operates in a similar manner with newly received data advancing pointer 110 and newly extracted data advancing pointer 116. The new data, however, may contain gaps, as depicted by arrow 120 on the liner representation of the FIFO buffer, representing a lost packet.

FIG. 5 depicts the more detailed operation at receive buffer 24 for detection of gaps in the packet sequence by use of the sequence number, in a manner consistent with certain preferred embodiments. In this illustration, the process is shown as 150 and starts at 152. The value T represents the packet sequence number of the currently received packet, while P represents the packet sequence number for the previously received packet. In this embodiment, the receive buffer is realized as a memory with an associated double linked list referred to as a gap linked list in order to identify gaps in the received data.

At 154, the process awaits arrival of a packet. When a packet arrives at 154, T is compared with P and if T is not <P, control passes to 160, where T and P are again compared. If T is not >P+1 at 160, then the packet is received in order and control is passed to 164 where the packet is appended to the ring buffer in the next location. The location can be tracked using a linked list as previously described.

If at 158, T<P, the process follows the gap linked list to find where the packet belongs, since T<P indicates that the current packet is numbered lower than the current packet, and thus should have been received earlier. If the location where the packet belongs is found at 172, the packet is inserted at the proper location. If not, the packet is discarded at 180. In either event, control returns to 154 to await arrival of the next packet.

If at 160, T>P+1, a gap in the packets has been encountered. This gap information is recorded in the gap linked list at 184 and the packet is appended to the packet in the ring buffer. A retransmission request is then made at 188 and the process returns to 154 to await the next packet.

Those skilled in the art will appreciate that many mechanisms can be used to track the location of a gap in the stream of received packets, with the above example using a gap linked list being but one example. In other example embodiments, the buffer need not necessarily be a circular buffer, and the gaps in the received packets need not necessarily be tracked using linked list or double linked list. Other embodiments will occur to those skilled in the art.

Using various embodiments consistent with the present invention, a retransmission request for a sequence of missing packets can be generated and transmitted quickly at the receiving side. Additionally, the packet can be located (or not) and retransmitted (or not) very quickly at the transmitting side in order to maximize the likelihood of an effective retransmission. Moreover, the process is simple to implement and can result in a decrease in the number of gaps in a stream of packets at the receiver at minimal cost and complexity.

While certain embodiments herein were described in conjunction with specific circuitry that carries out the functions described, other embodiments are contemplated in which the circuit functions are carried out using equivalent software or firmware embodiments executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

Software and/or firmware embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

The above description of certain embodiments of the invention is focused on operation between one transmitter and one receiver. However, other embodiments consistent with this invention are also applicable when a single transmitter is serving multiple receivers by using multicast technique which increases number of service recipients without increasing the network bandwidth. Because there is no handshake mechanism the retransmission request processor can handle requests from more than one receiver in nondiscriminatory fashion.

While certain illustrative embodiments have been described, it is evident that many alternatives, modifications, permutations and variations will become apparent to those skilled in the art in light of the foregoing description.

What is claimed is:

1. A retransmission method for use in handshakeless communication, comprising:
transmitting a sequence of packets from a packet source to a packet receiving device, each packet in the sequence of packets having a sequence number associated therewith, said transmitting including retrieving a next packet from a transmission buffer and transmitting said next packet;
at the packet receiving device, determining that a packet or a sequence of packets have not been received by determining that a gap exists in the sequence numbers of received packets;
sending a retransmission request from the receiving device to the transmitting device, such retransmission request requesting retransmission of a specified sequence of packets whose sequence numbers fill the gap in sequence numbers;
at the packet source, receiving the retransmission request for the specified sequence of packets;
at the packet source, determining if the specified sequence of packets remain available in the transmission buffer;
if the specified sequence of packets are available in the transmission buffer, retransmitting the specified packets to the receiving device; and
if the specified sequence of packets are not available in the transmission buffer, ignoring the retransmission request.

2. The method according to claim 1, wherein the receiving device has a receive buffer, and wherein received packets are placed in the receive buffer, and wherein the position of each packet in the receive buffer is tracked using a first linked list.

3. The method according to claim 2, wherein the first linked list uses pointers to point to adjacent packets in the packet sequence, or to most nearly adjacent packets in the packet sequence when a gap in sequence numbers exists.

4. The method according to claim 2, wherein the existence of a gap in received sequence numbers is tracked using a second linked list, where the second linked list contains a null entry for each packet having a corresponding next and previous packet sequence numbered packet in the buffer, and wherein the second linked list has a sequence number for each sequence number missing due to a gap in received packets.

5. The method according to claim 3, wherein the existence of a gap in received sequence numbers is tracked using a second linked list, where the second linked list contains a null entry for each packet having a corresponding next and previous packet sequence numbered packet in the buffer, and wherein the second linked list has a sequence number for each sequence number missing due to a gap in received packets.

6. The method according to claim 2, wherein the existence of a gap in received sequence numbers is tracked using a second linked list.

7. The method according to claim 2, wherein the first linked list comprises a double linked list.

8. The method according to claim 2, wherein the receive buffer comprises a circular buffer.

9. The method according to claim 3, wherein the transmit buffer comprises a circular buffer.

10. The method according to claim 1, wherein the packets comprise UDP format packets.

11. The method according to claim 1, wherein existence of a gap in the sequence of packets is tracked at the receiving device using a gap linked list.

12. A retransmission method for use in handshakeless communication, comprising:
transmitting a sequence of packets from a packet source to a packet receiving device, each packet in the sequence of packets having a sequence number associated therewith, said transmitting including retrieving a next packet from a circular transmission buffer and transmitting said next packet;
at the packet receiving device, determining that a packet has not been received by determining that a gap exists in the sequence numbers of received packets;
sending a retransmission request from the receiving device to the transmitting device, such retransmission request requesting retransmission of a specified sequence of packets whose sequence numbers fill the gap in sequence numbers;
at the packet source, receiving the retransmission request for the specified packets;
at the packet source, determining if the specified packets remain available in the transmission buffer;
if the specified packets are available in the transmission buffer, retransmitting the specified packets to the receiving device;
if the specified packets are not available in the transmission buffer, ignoring the retransmission request;
wherein the receiving device has a circular receive buffer, and wherein received packets are placed in the receive buffer, and wherein the position of each packet in the receive buffer is tracked using a first linked list, wherein the first linked list uses pointers to point to adjacent packets in the packet sequence, or to most nearly adjacent packets in the packet sequence when a gap in sequence numbers exists; and
wherein the existence of a gap in received sequence numbers is tracked using a second linked list, where the second linked list contains a null entry for each packet having a corresponding next and previous packet sequence numbered packet in the buffer, and wherein the second linked list has a sequence number for each sequence number missing due to a gap in received packets.

13. The device according to claim 12, wherein the packets are UDP format packets.

14. A transmitter device for handshakeless communication, comprising:
a transmitter that transmits a sequence of packets from a packet source to a packet receiving device, each packet in the sequence of packets having a sequence number associated therewith, said transmitting including retrieving a next packet from a transmission buffer and transmitting said next packet;
a receiver for receiving a retransmission request for a specified sequence of packets;
means for determining if the specified sequence of packets remain available in the transmission buffer;
if the specified packets are available in the transmission buffer, retransmitting the specified packets to the receiving device; and
if the specified packets are not available in the transmission buffer, ignoring the retransmission request.

15. The device according to claim 14, wherein the transmit buffer comprises a circular buffer.

16. The device according to claim 14, wherein the packets comprise UDP format packets.

17. The device according to claim 14, wherein the packets are transmitted using a handshakeless protocol wherein there is no acknowledgement of receipt of packets.

18. The device according to claim 14, wherein the retransmission request is not acknowledged.
